(19) United States
(12) Patent Application Publication
(10) Pub. No.: US 2006/0272005 A1
(43) Pub. Date: Nov. 30, 2006

(54) Security optimization techniques for web applications

(75) Inventors: Glenn Ammons, Albany, NY (US); Jong-Deok Choi, Mount Kisco, NY (US); Manish Gupta, Yorktown Heights, NY (US); Nikhil Swamy, Washington, DC (US)

Correspondence Address: MICHAEL J. BUCHENHORNER, 8540 S.W. 83 STREET, MIAMI, FL, 33143, US

(73) Assignee: International Business Machines Corporation

(21) Appl. No.: 11/135,744

(22) Filed: May 24, 2005

(51) Int. Cl. H04L 9/00; H04L 9/32; G06F 17/00; G06K 9/00; H04K 1/00; G06F 17/30; G06F 7/04

(52) U.S. Cl. 726/2; 726/1

(57) ABSTRACT

A method for determining whether to provide a requested service includes steps of receiving a current request for at least one secure service; searching a cache for a stored decision on whether to provide the at least one secure service, wherein the stored decision was made responsive to a prior request that is equivalent to the current request; using the stored decision when the stored decision is found; and performing a security check to determine whether a requested secure service can be granted, if the stored decision is not found. According to other embodiments, the method can be implemented as a computer readable medium including program instructions for performing the method or as an information processing system comprising a processor and memory for performing the method.

### FIELD OF THE INVENTION

The invention disclosed broadly relates to the field of security systems and methods and more particularly relates to the field of optimizing the costs of performing security checks in processes.

### BACKGROUND OF THE INVENTION

Application servers such as IBM's WebSphere Application Server have security features that are expensive to operate (i.e., consume substantial processing and storage resources). Thus, enabling security entails a large performance overhead.

J. M. Juran's Pareto principle (also known as the 80/20 rule) admonishes, “Concentrate on the vital few, not the trivial many.” For software systems, the Pareto principle says that aggressively optimizing a few execution paths yields large speedups. The principle holds even for large systems like web applications, for which finding the “vital few” execution paths is especially difficult. Consequently, finding bottlenecks in such systems has been the focus of much previous work. One such bottleneck the determination made by an application server on whether to provide a requested secure service. The greater the level of security, the more severe is the bottleneck

Therefore, there is a need for finding bottlenecks (i.e., the most resource consuming part of a process), given (possibly extremely large) profiles of one or more executions of a system to reduce the security overhead. There is a particular need for a server system that avoids bottlenecks on processing requests for service.

### SUMMARY OF THE INVENTION

Briefly, according to one embodiment of the invention a method for determining whether to provide a requested service comprises steps of receiving a current request for at least one secure service; searching a cache for a stored decision on whether to provide the at least one secure service, wherein the stored decision was made responsive to a prior request that is equivalent to the current request; using the stored decision when the stored decision is found; and performing a security check to determine whether a requested secure service can be granted, if the stored decision is not found. According to other embodiments, the method can be implemented as a computer readable medium including program instructions for performing the method or as an information processing system comprising a processor and memory for performing the method.

### BRIEF DESCRIPTION OF THE DRAWINGS

FIG. 1 is a flowchart of a method 100 for determining whether a system grants a request for a secure service according to an embodiment of the invention.

FIG. 2 is a high level block diagram showing an information processing system according to the invention.

FIG. 3 is a block diagram showing an original CheckRole code according to an embodiment of the invention.

FIG. 4 is a block diagram showing an optimized code with CachingCheckRole according to an embodiment of the invention.

### DETAILED DESCRIPTION

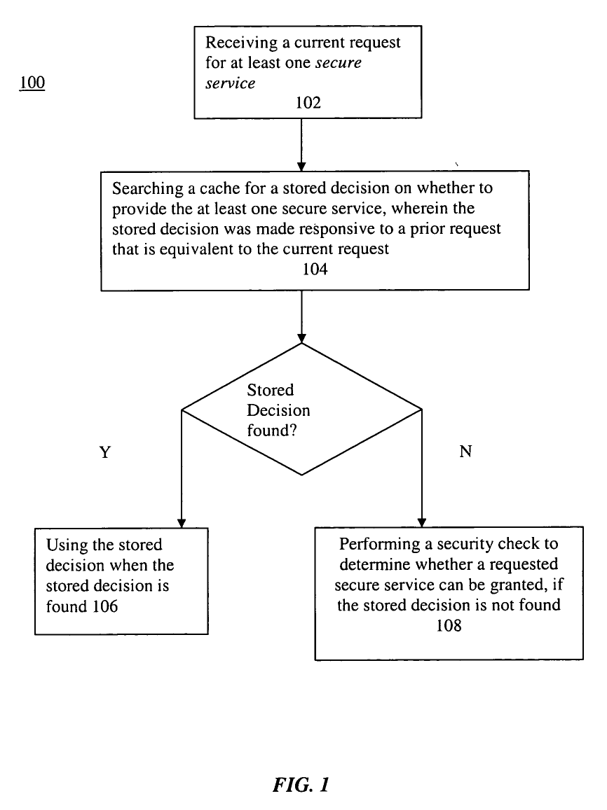

Referring to FIG. 1, there is shown a flow chart illustrating an information processing method 100 according to an embodiment of the invention. In step 102 the system receives a current request for at least one secure service. A secure service is a service that is subject to security constraints such that the service can only be provided under certain conditions. Thus, the system must determine whether to provide the service sought by the user requesting it.

In step 104 the system searches a cache for a stored decision on whether to provide the requested secure service. In one possible case, the stored decision was made in response to a prior request that is equivalent to the current request. For example, the stored decision can be one of a plurality of decisions made, on substantially the same data, a plurality of times in close succession. This exploits a temporal redundancy used in systems that use Java securities checks. A security check exhibits high temporal redundancy if the check makes the same decision based on the same data several times in close succession. For example, a check that repeatedly tests if the same user may invoke certain Java bean methods that are protected by the same role. Temporal redundancy can be exploited by using caching of prior security results exhibiting high temporal redundancy for later use in subsequent decisions. The results of an expensive search can be stored in the cache and indexed by the data that formed the basis of the decision. If the decision is the cache a subsequent check can be avoided and thus a bottleneck condition is avoided. Note that the caching is effective only when cache hits are sufficiently frequent and the cost of cache lookups and maintenance is sufficiently inexpensive. We use specialization to exploit spatial redundancy. The frequent code path is copied and the expensive search is replaced with the cheaper version adapted specifically to that path. Specialization is effective only when the benefit of the adapted substitute check outweighs the cost of duplicating code.

Another example of a prior decision is where the stored decision is one of a plurality of decisions based on a plurality of security checks using the same code path. This exploits another aspect of Java security checks called a spatial redundancy. A security check exhibits high spatial redundancy if the check frequently makes the same decision because it is reached by the same code path. For example, consider a checkpermission that is executed repeatedly in the same calling context. The stored decision can also be one that was made based on a plurality of predetermined security criteria.

In step 106 the system uses the stored decision when the stored decision is found. In step 108 the system performs a security check to determine whether a requested secure service can be granted, if the stored decision is not found.

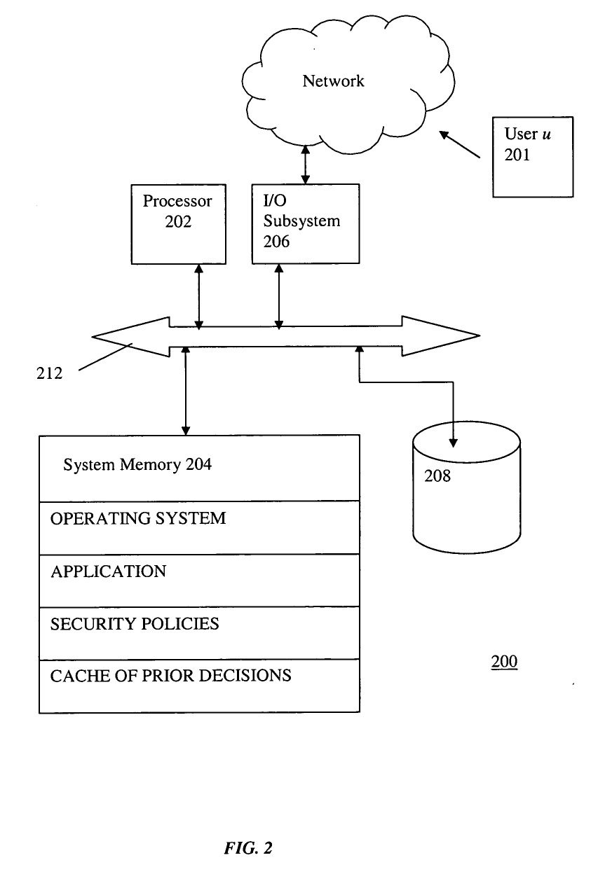

Referring to FIG. 2, there is shown a block diagram of an information handling system 200 according to an embodiment of the invention. In this example the system 200 is an application server using J2EE (Java 2 Platform, Enterprise Edition), which is a collection of Java interfaces and classes used for business applications. The system 200 includes a container that hosts Enterprise Java Beans (EJBs). In J2EE, applications are constructed from EJBs, providing services such as database access and messaging, as well as managing resources such as threads and memory. In this embodiment, the system 100 is a server that includes some secure services. The system 200 comprises a processor 202, a memory 204, and an input/output (I/O) subsystem 206. A user 201 requests services from the system 200.

The memory 204 represents either a random-access memory or mass storage. It can be volatile or non-volatile. The system 200 can also comprise a magnetic media mass storage device such as a hard disk drive 208.

The I/O subsystem 206 comprises a connection to a network such as a local-area network (LAN) or side-area network (WAN) such as the Internet.

The system 200 uses J2EE security model which allows an administrator to associate roles with methods and with users. When global security is enabled, the system inserts an access check before each bean method call. If there is a role that is associated with both the current user and with the method, then the call is allowed; otherwise, it is forbidden. The following pseudocode shows the routine that checks whether a user u 201 can execute method m.

Check Role Optimization

The J2EE security model allows an administrator to associate roles with methods and with users. When global security is enabled, the server 200 inserts an access check before each bean method call. If there is a role that is associated with both the current user and with the method, then the call is allowed; otherwise, it is forbidden. The following pseudocode shows the routine that checks whether a user u can execute method m.

Boolean CheckRole(User u, Method m)
{

if ((UserRoles(u) 3 MethodRoles(m)) γ empty_set)

return true

else

return false

}
where UserRoles(u) and MethodRoles(m) returns the sets of roles of
user u and method m, respectively.
Our optimization consists of a decision cache (DC) and a new routine
called cachingCheckRole (shown below), which is a wrapper of
CheckRole above.
Boolean CachingCheckRole(User u, Method m)
{

if (DC.lookup(u, m))

return true

else if (CheckRole(u, m))

{

DC.add(u, m);
return true

}

else

return false

}

DC.lookup(u, m) returns true if <u, m> pair is in the decision cache; otherwise, it returns false. DC.add(u, m) adds <u, m> pair to the decision cache.

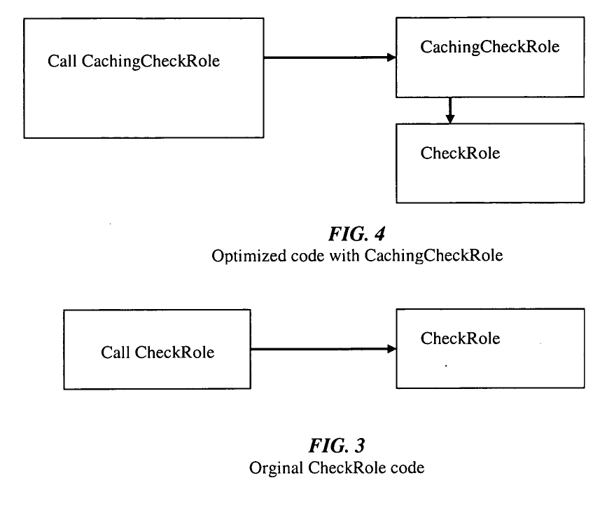

Finally, we convert all the invocation sites of CheckRole in the original code into invoking CachingCheckRole. FIGS. 3 and 4 show a high level illustration of the original and the optimized code.

User Object Memoization

The decision cache, DC, uses the User object u and the Method object m. The Method object of a given a method does not change for a given J2EE system. In contrast, a user can have a new User object created each time the user makes a request to a J2EE system. This either fails the caching if the caching is based on the identity of the User objects, or makes the caching inefficient if it is based on the identity of the contents of the User objects, such as the identification of the user represented by a User object. We improve the performance of the DC caching by employing User-Object memoization. With this scheme, we keep User objects and remember (or, memorize) the users represented by them. Later when a user makes a new request to the J2EE system, we try to use the same User object that represented the user before. Since the same User object is used for the same user, an efficient caching based on the object identity can be used instead of more expensive caching schemes based on the object-content identity.

Database Connection Pooling

Because creating a database connection is expensive, the system 200 reuses them: when a transaction starts, system 200 assigns it a connection from a pool of available connections; when a transaction completes, its connection is returned to the pool so that it can be used again.

In J2EE, a Subject represents information about a user or other entity. When security is enabled, system 200 associates a Subject with each database connection. This association complicates connection pooling, because system 200 must ensure that a database connection that is opened on behalf of one user is never used on behalf of a different user.

Once again, we used caching to remove this overhead. Most of the overhead of the check was related to checking equality of Subjects and computing hash codes for Subjects. These operations are expensive because Subjects contain private credentials, which cannot be read without first passing a permission check. Our caches avoid this expense by remembering the results of equality checks and hash code computations.

The following pseudocode represents the original (unoptimized) way.

DBConnection getPooledConnection(p1, . . ., pn)
{

Subject s = new Subject(p1, . . ., pn);
s.hashVal = Hash(s); // very expensive
. . .
forall available connections c
{

if (c.connection_user.equals(s)) // very expensive

return c;

}
return null; // nothing in the pool

}
where c.connection_user.equals(s) is comparing the content of s with
that of c.connection_user, which is very expensive. The following
pseudocode represents our optimized way.
DBConnection getPooledConnection(p1, . . ., pn)
{

```
Subject s = subjectIfCached(p1, . . ., pn);
if (s == null) // frequently false
{
  s = new Subject (p1, . . ., pn);
  addSubjectToCache(s, p1, . . ., pn);
}
// In the following (s.hashVal == 0) indicates it has not been
```

hashed.

if (s.hashVal == 0) // usually false

s.hashVal = Hash(s); // very expensive

. . .
forall available connections c
{

if ((c.connection_user == s) // very cheap, and usually true

||(c.connection_user.equals(s))) // very expensive
return c;

}
return null; // nothing in the pool

}

Specialization Optimization (GetCredentials)

As in the case of the database reuse optimization above, this optimization speeds up an operation that depends on reading private credentials. However, while the database reuse is a temporal optimization, this optimization is spatial. The optimization is an instance of a general technique for removing Java 2 permission checks.

Permission checking in Java 2 security is complicated, but we can suppose that it provides two primitives: checkpermission and doPrivileged.

The checkpermission method receives a permission object as its only argument, and walks the call-stack to verify that the code has the permission represented by the object. Intuitively, on a call of checkPermission, the Java runtime visits each call on the call-stack, visiting each callee before its caller. At each call, the runtime consults a table (prepared by the administrator) to decide whether the invoked method has the permission or not. If the runtime finds a method that does not have the permission, it raises an exception.

A doPrivileged call is used to cut off the stack walk. If, while walking the stack, the runtime finds a doPrivileged call, it stops the walk. Thus, the walk's outcome cannot depend on the calling context of the doPrivileged. Our optimization exploits this property. The following pseudocode illustrates the optimization:

Class PrivilegedClass
{

Invoker( )
{

doPrivileged( );
CheckingClass.GetCredentials(a1, . . ., an); // a1 ... an are

arguments.

}

}
Class CheckingClass
{

static GetCredentials(p1, . . ., pn) // p1 ... pn are parameters
{

checkPermission(constant_permission_object) ;
return secret_credentials;

}

}

Class CallingClass
{

private static Object secret = new Secrets( );
private bool succeeded = false;
bool checkSecret(Object o)
{

return (secret == o) // Is o the same as secret?

}
Invoker( )
{

if (succeeded)

creds = GetCredentials(a1, . . . an, secret) //

additional parameter

else

{

doPrivileged( );
creds = GetCredentials(a1, . . . an, secret);
succeeded =true;

}

}

}
Class CheckingClass
{

private bool succeeded = false;

GetCredentials(pl, . . . , pn, Secret o)
{

if ( — CallingClass.checkSecret(o))

checkPermission (constant_permission_object)

else if ( — succeeded)

{

checkPermission(constant_permission_object);
succeeded = true;

}

return secret_credentials;

}

}

The optimized code performs a full security check just once; if the check succeeds (the common case), then any further calls perform a fast security check. The fast check uses a secret object, known only to CallingClass, to verify that the caller is CallingClass.Invoker. Because the secret is private to CallingClass and escapes only to GetCredentials, it cannot be forged. So, if attacking code calls GetCredentials, its permissions will be checked in the normal, safe way.

There is a caveat: once the permission checked by GetCredentials is granted to CallingClass.Invoker, it must never be revoked. In this instance, the caveat is not problematic—if the code in question did not have the permission, then WAS would not work.

There are other ways to implement this optimization safely. First, the runtime could detect such redundant security checks and rewrite the jited code (as we rewrote the source code) to avoid them. This solution would require no source changes at all and would automatically optimize away other occurrences of the pattern. Second, one could add a module system to Java (such as {corwin-oopsla03}), which would allow a programmer to say statically that GetCredentials may only be called by Invoker. Finally, instead of passing the secret as a parameter of GetCredentials, the secret could be stored in a thread-local variable. This last approach avoids changing the signature of GetCredentials but is slow on many JVMs, for which accessing thread-local storage is expensive.

Finding bottlenecks in large systems by hand is hard because of two related problems: choosing the best way to summarize execution-cost measurements, and keeping track of overlap among bottlenecks.

According to an embodiment of the invention, a computer readable medium, such as a CDROM can include program instructions for operating the programmable computer according to the invention.

What has been shown an discussed is a highly-simplified depiction of a programmable computer apparatus. Those skilled in the art will appreciate that other low-level components and connections are required in any practical application of a computer apparatus. Therefore, while there has been described what is presently considered to be the preferred embodiment, it will understood by those skilled in the art that other modifications can be made within the spirit of the invention.

We claim:

1. A method, for determining whether to grant a request for a secure service, comprising steps of:
receiving a current request for at least one secure service;
searching a cache for a stored decision on whether to provide the at least one secure service, wherein the stored decision was made responsive to a prior request that is equivalent to the current request;
using the stored decision when the stored decision is found; and
performing a security check to determine whether a requested secure service can be granted, if the stored decision is not found.

2. The method of claim 1, wherein the stored decision is one of a plurality of decisions made on substantially the same data a plurality of times in close succession.

3. The method of claim 1, wherein the stored decision is one of a plurality of decisions based on a plurality of security checks using the same code path.

4. The method of claim 1, wherein the stored decision was made based on a plurality of predetermined security criteria.

5. The method of claim 3, wherein the security criteria comprise identification of the user.

6. The method of claim 3 wherein the security criteria comprise identification of the service requested.

7. The method of claim 3 wherein the security criteria comprise a current security policy.

8. The method of claim 1, wherein before receiving the request, the method further comprises:
storing the plurality of decisions based on prior requests, wherein the prior requests were received prior to the request currently received.

9. The method of claim 7 wherein the code path is copied and replaced with a less expensive security check tailored specifically to the code path for use in processing subsequent requests.

10. The method of claim 7 wherein the step of searching a cache further comprises performing a search of the cache for cache for a stored decision whether to provide the at least one security service, wherein the stored decision is one of a plurality of decisions based on substantially the same data a plurality of times in close succession.

11. An information processing system comprising:
an input configured for receiving requests for secure services;
a storage subsystem configured for caching the requests for secure services and decisions made on the requests;
a processor configured for searching the cache for a stored decision whether to provide the at least one secure service, searching a cache for a stored decision on whether to provide the at least one secure service, wherein the stored decision was made responsive to a prior request that is equivalent to the current request; for using the stored decision when the stored decision is found; and performing a security check to determine whether a requested secure service can be granted, if the stored decision is not found.

12. The system of claim 11 wherein the stored decision is one of a plurality of decisions made on substantially the same data a plurality of times in close succession.

13. The system of claim 11 wherein the stored decision is one of a plurality of decisions based on a plurality of security checks using the same code path.

14. The system of claim 10 wherein the security criteria comprise identification of the user.

15. The system of claim 10 wherein the security criteria comprise identification of the service requested.

16. The system of claim 10 wherein the security criteria comprise a current security policy.

17. A computer readable medium comprising program instructions for receiving a request for at least one security service;
receiving a request for at least one secure service;
searching a cache for a stored decision whether to provide the at least one security service, wherein the stored decision was made responsive to a prior request that is equivalent to the current request;
using the stored decision when the stored decision is found; and
performing a security check to determine whether a requested secure service can be granted, if the stored decision is not found.

18. The computer readable medium of claim 17 wherein the stored decision is one of a plurality of decisions made on substantially the same data a plurality of times in close succession.

19. The computer readable medium of claim 17, wherein the stored decision is one of a plurality of decisions based on a plurality of security checks using the same code path.
